(19) United States
(12) Patent Application Publication
(10) Pub. No.: US 2010/0102547 A1
(43) Pub. Date: Apr. 29, 2010

(54) WATER METER PIT ASSEMBLY

(76) Inventor: Nathan Manuel, Redondo Beach, CA (US)

Correspondence Address: CARLSON, GASKEY & OLDS, P.C., 400 WEST MAPLE ROAD, SUITE 350, BIRMINGHAM, MI, 48009, US

(21) Appl. No.: 12/257,414

(22) Filed: Oct. 24, 2008

(51) Int. Cl. E03B 7/07; B23P 11/00

(52) U.S. Cl. 285/30; 29/428

(57) ABSTRACT

A water meter pit assembly includes a plastic frame and a plastic cover. The plastic frame is to be supported on a water meter column that extends upwardly from a water meter pit. The plastic cover is releasably secured to the plastic frame so that the plastic cover can be detached when needed to provide access to water meter components that are located within the water meter pit.

### TECHNICAL FIELD

The subject invention relates to a water meter pit assembly with a plastic frame and cover structure to enclose a water meter pit.

### BACKGROUND OF THE INVENTION

Water meters are used to monitor the amount of water distributed to specific locations, such as municipalities, businesses, and residences for example. Typically, a water meter is placed in a water meter pit. A water supply pipe extends across a bottom of the pit and the water meter is installed to monitor the water flow. A column extends upwardly from a bottom of the pit and supports a frame and cover assembly that enclose the water pit. The cover is usually flush with ground level, thus the frame assembly and cover must be sufficiently strong to support significant weight loads.

In one known configuration, the frame assembly is made from cast iron or aluminum frame members and includes a metal cover. The cover is removed and a service technician can then look down through a center of the column to read the meter. This manual reading process was time consuming and labor intensive.

A wireless transmission system was proposed to more efficiently transfer information concerning the water flow. The wireless signal is transmitted from the water meter to a recipient located near the water pit. The wireless signal includes information concerning the water flow. A wire extends upwardly from the water meter to a signal transmitter that is supported on the metal frame assembly. In this configuration the metal cover is replaced by a plastic cover so that the wireless signal can be transmitted to the recipient.

Current frame and cover assemblies are heavy and cumbersome to install within the water meter pit. Further, these frame and cover assemblies do not always effectively transmit signals. The subject invention seeks to provide a light-weight assembly that can more effectively transmit signals but which still provides sufficient structural rigidity to support significant weight loads.

### SUMMARY OF THE INVENTION

A water meter pit assembly includes a plastic frame and a plastic cover. The plastic frame is to be supported on a water meter column that extends upwardly from a water meter pit. The plastic cover is releasably secured to the plastic frame so that the plastic cover can be detached when needed to provide access to water meter components that are located within the water meter pit.

In one example, the plastic frame comprises a modular assembly that includes at least a base portion to be supported by the water meter column, a frost plate, and at least one spacer. The spacer is snap-fit to the base portion and the frost plate is inserted supported by an inwardly extending flange portion formed on an inner peripheral surface of the spacer. The plastic cover is then attached to the spacer.

In one example, if a height of the plastic frame assembly needs to be increased, a second spacer can be attached to the first spacer. Additional spacers can be attached to the second spacer if needed to further increase the height of the plastic frame.

In one example, attachment interfaces between the base portion and the spacers comprise snap-fit attachments.

In one example, the plastic frame supports a signal generator that transmits water meter information from a water meter to a recipient. The plastic frame includes at least one wire guide surface to support a wire connection extending from the signal generator, down through the water pit column, to the water meter.

These and other features of the present invention can be best understood from the following specification and drawings, the following of which is a brief description.

### BRIEF DESCRIPTION OF THE DRAWINGS

FIG. 1 is a schematic representation of a water meter pit, water meter, and water meter pit assembly including a frame and cover.

FIG. 2 is an exploded view of the water meter pit assembly.

FIG. 3 is a perspective view of an assembled water meter pit assembly without the cover.

FIG. 4 is a side view of the assembly of FIG. 3.

FIG. 5 is a top view of the assembly of FIG. 3.

FIG. 6 is a perspective view of a base portion of the water meter pit assembly.

FIG. 7 is a perspective view of a large size spacer of the water meter pit assembly.

FIG. 8 is a perspective view of a frost plate of the water meter pit assembly.

FIG. 9 is a perspective view of a small size spacer of the water meter pit assembly.

### DETAILED DESCRIPTION OF THE PREFERRED EMBODIMENT

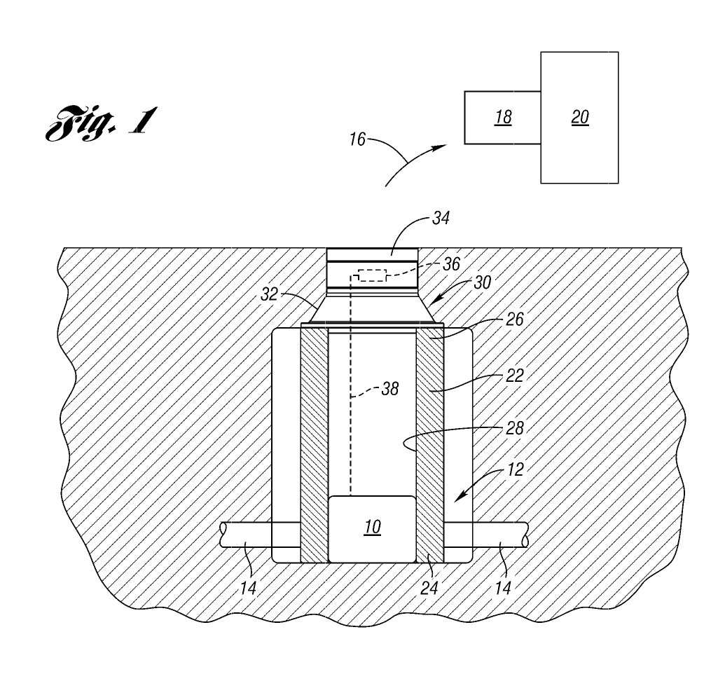

A water meter 10 is located in a water meter pit 12 as shown in FIG. 1. A water supply pipe 14, which is buried underground, is used to deliver water to specific locations, such as a businesses or residences for example. The water meter 10 monitors and measures the amount of water that is used for a specific location. This water meter data is transmitted via a wireless signal 16 to a receiving device 18 associated with a data collection device 20, such as a computer or hand-held meter reader for example, which is located above ground.

A water pit column 22 includes a first end 24 that is supported on a floor of the water meter pit 12, and which extends upwardly to a second end 26. The water pit column 22 includes a central opening 28 that extends from the first end 24 to the second end 26. The water meter 10 is at least partly received within this central opening 28.

A water meter pit assembly 30 rests on top of the second end 26 of the water pit column 22. The water meter pit assembly 30 includes a plastic frame 32 and a plastic cover 34 that is releasably secured to the plastic frame 32 such that the plastic cover 34 can be selectively attached and detached from the plastic frame 32 to provide access to components located within the water meter pit 12. Any type of plastic material can be used to form the cover and frame. The plastic cover 34 is usually positioned to be flush with ground level but could also be slightly raised or lowered relative to ground level.

The plastic frame 32 supports a transmitting component 36, such as a signal generator for example, that is connected to the water meter 10 with at least one wire connection 38. The wire connection 38 extends downwardly from the plastic frame 32 through the central opening 28 in the water pit column 22, to where it is connected to the water meter 10. Data from the water meter 10 is then wirelessly transmitted by the transmitting component 36 to the receiving device 18. Any type of transmitting component and receiving device can be used to transmit and receive data from the water meter 10.

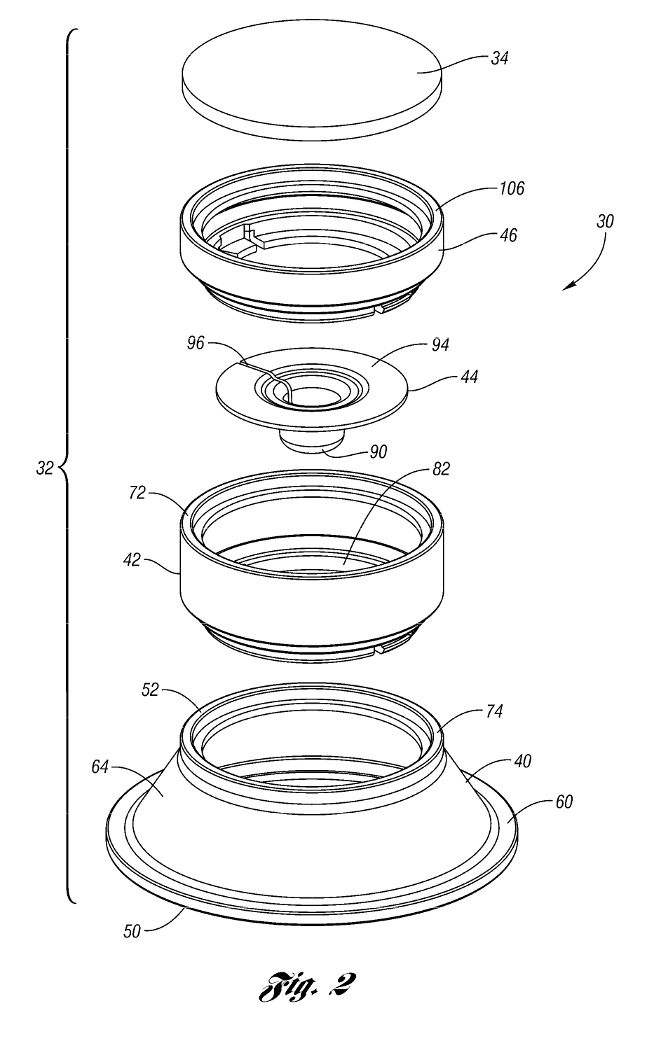

The water meter pit assembly 30 is shown in greater detail in FIG. 2. The plastic frame 32 includes a base portion 40 and at least one spacer 42. Additional spacers 46 (only one is shown) can optionally be included to increase the height of the plastic frame 32 as needed. Further, an optional frost plate 44 can also be included as part of the plastic frame 32. When the spacers and/or the frost plate 44 are utilized, the base portion 40, the spacers 42, 46, and frost plate 44 are pre-assembled together to form a modular frame unit or assembly that can be easily installed on the meter pit 12. However, certain applications may only require the base portion 40. The plastic cover 34 can be attached as part of the modular unit or can be separately attached after the plastic frame 32 is installed within the meter pit 12.

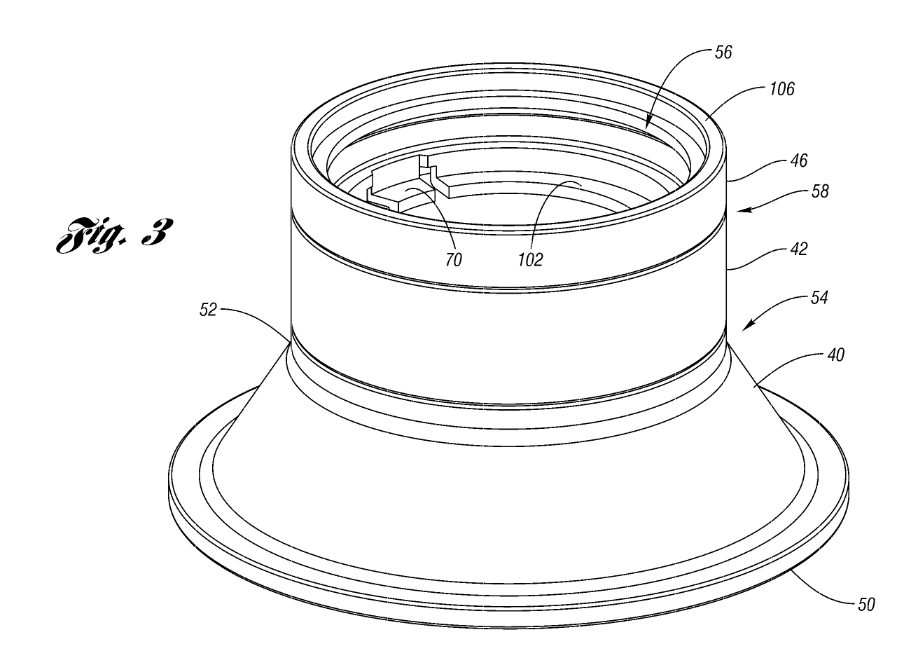

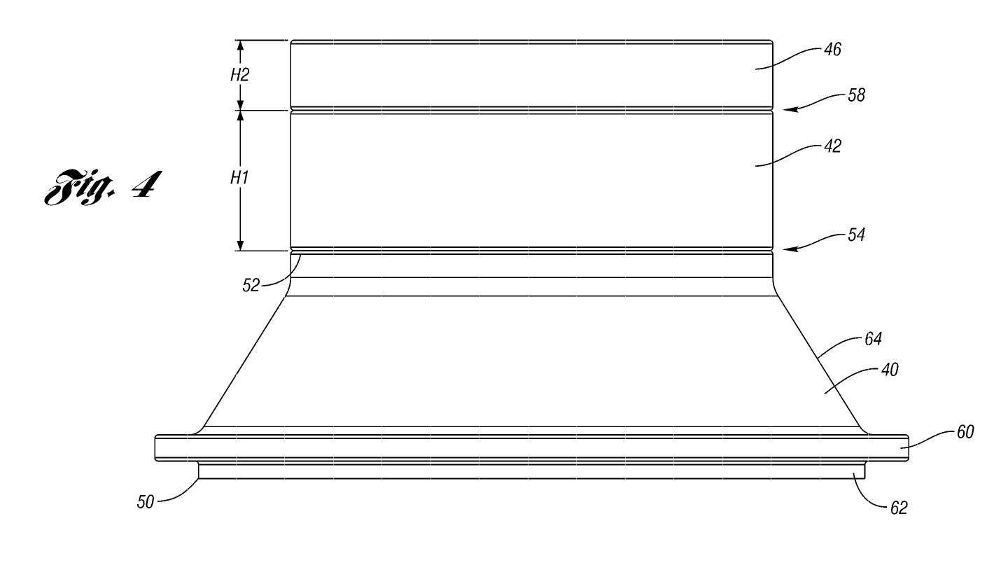

FIGS. 3-5 show the plastic frame 32 in the assembled condition. The base portion 40 includes a first end 50 that rests on top of the water pit column 22 and a second end 52 that is secured to the spacer 42 at a first attachment interface 54. The frost plate 44 is supported by the spacer 42 within an internal cavity 56 defined by the plastic frame 32. The second spacer 46 is secured to the spacer 42 at a second attachment interface 58. As best shown in FIGS. 3-4, the spacer 42 is defined by a first height H1 and the second spacer 46 is defined by a second height H2 that is less than the first height H1. In one example, the first height is 6 inches and the second height is 2 inches; however, the heights could be varied as needed. Further, the heights of the secondary or additional spacers 46 can be varied, or multiple spacers with the same or different heights can be attached to spacer 42 to adjust the overall height of the plastic frame 32. This may be necessary when the cover 34 is to be at a slightly raised position relative to ground level.

As shown in FIG. 4, the base portion 40 includes an outer flange 60 that is formed about an outer periphery of the first end 50 of the base portion 40. A downwardly extending lip portion 62 is formed at the first end 50 and is received within the central opening 28 of the water pit column 22. A bottom surface of the outer flange 60 rests on an upper edge of the water pit column 22 when the lip portion 62 is inserted into the central opening 28. Thus, the outer flange 60 and lip portion 62 cooperate to seat and fix the plastic frame 32 in position relative to the water pit column 22.

The base portion 40 includes a tapered outer surface 64 that decreases in diameter from the outer flange 60 to the second end 52. The outer flange 60 defines the largest diameter of the base portion 40 and the second end 52 defines the smallest diameter.

As discussed above, the base portion 40 and the spacer 42 are secured to each other at a first attachment interface 54 and the spacers 42, 46 are secured to each other at a second attachment interface 58. In one example, the first 54 and second 58 attachment interfaces comprise snap-fit attachments. An example of the snap-fit attachment is shown in FIG. 5 where the second spacer 46 includes one or more resilient tabs 70 that are snap-fit to a flange portion 72 of the spacer 42.

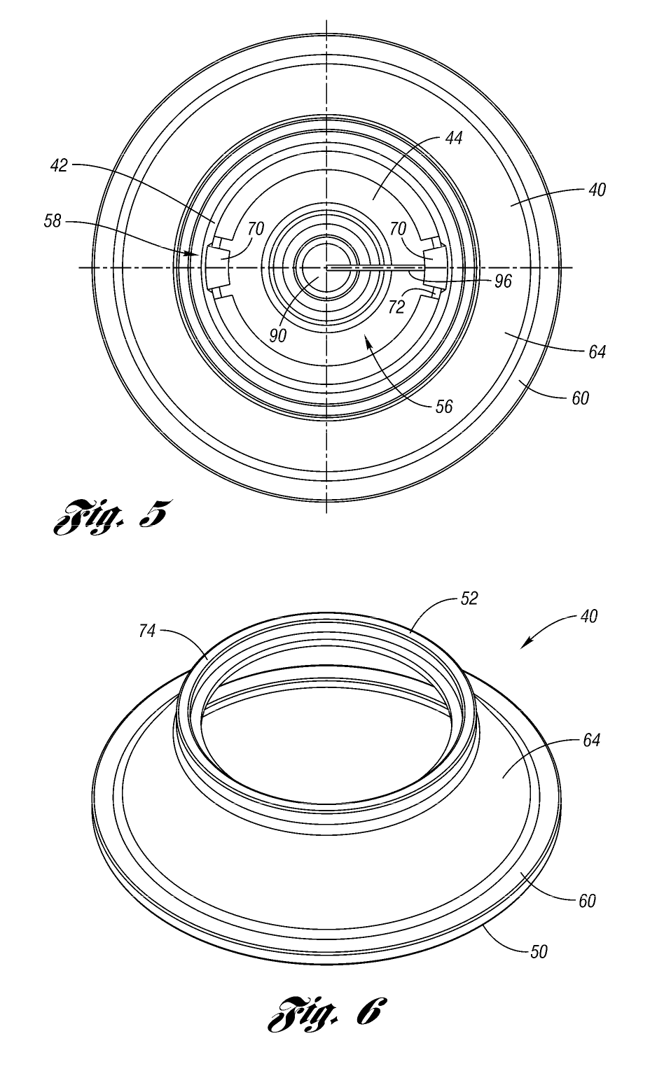

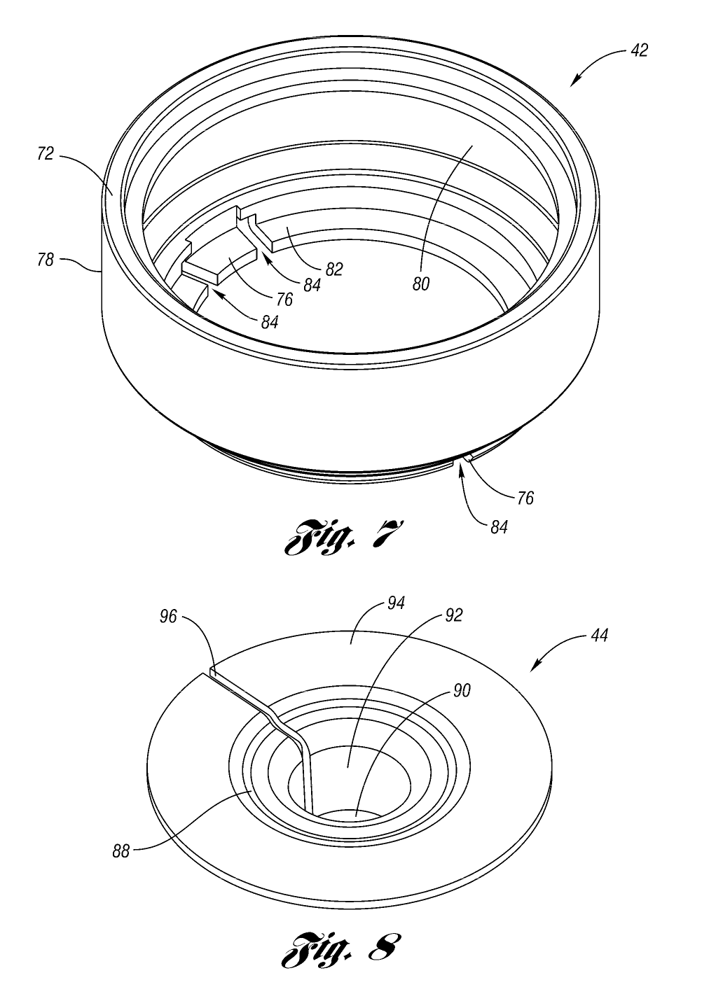

A similar tab and flange arrangement is used to secure the spacer 42 to the base portion 40. As shown in FIG. 6, the base portion 40 comprises a tubular or ring-shaped member that includes a flange portion 74 that extends about an outer periphery of the second end 52. As shown in FIG. 7, the spacer 42 includes one or more resilient tabs 76 that are snap fit over the flange portion 74 to secure the spacer 42 to the base portion 40.

The spacer 42 also comprises a tubular or ring-shaped member that includes an outer peripheral surface 78 and an inner peripheral surface 80. The resilient tabs 76 are formed on an inner flange 82 that extends inwardly from the inner peripheral surface 80. The inner flange 82 includes cut-outs 84 on either side of the tabs 76 such that the tabs 76 can be snap-fit onto the flange portion 74.

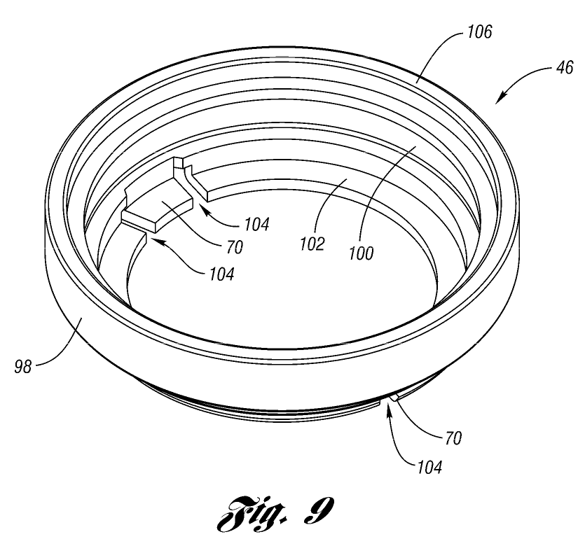

The inner flange 82 of the spacer 42 also provides a seat for the frost plate 44. As shown in FIG. 8, the frost plate 44 comprises a cup-shaped body 88 that has an enclosed bottom 90 that supports the transmitting component 36 (FIG. 1). The cup-shaped body 88 includes a vertically extending wall portion 92 that extends upwardly from the enclosed bottom 90 to an outwardly extending flange portion 94 formed about a periphery of the cup-shaped body 88. The outwardly extending flange portion 94 rests on the inner flange 82 (FIG. 7) of the spacer 42.

A wire guide surface 96 is formed within the cup-shaped body 88. The wire guide surface 96 extends upwardly along the vertically extending wall portion 92 and across the outwardly extending flange portion 94. The wire guide surface 96 supports the wire 38 (FIG. 1) that connects the water meter 10 to the transmitting component 36.

FIG. 9 shows an example of an additional spacer 46 that can be used to increase the height of the plastic frame 32 as needed. The spacer 46 comprises a tubular or ring-shaped member that includes the one or more resilient tabs 70 (see also FIG. 5) that are snap-fit to the flange portion 72 (FIG. 7) of the spacer 42. As shown, the flange portion 72 extends about an outer periphery of an upper end of the spacer 42. The resilient tabs 70 are snap fit over the flange portion 72 to secure the additional spacer 46 to the first spacer 42.

The spacer 46 includes an outer peripheral surface 98 and an inner peripheral surface 100. The resilient tabs 70 are formed on an inner flange 102 that extends inwardly from the inner peripheral surface 100. The inner flange 102 includes cut-outs 104 on either side of the tabs 70 such that the tabs can be snap-fit onto the flange portion 72. The cover 34 is then assembled onto an upper end 106 of the additional spacer 46 to enclose the water meter pit assembly 30 and protect the transmitting component 36.

Including a plastic frame 32 in the water meter pit assembly 30 improves signal transmission from the transmitting component 36. Also, the plastic frame 32 decreases the overall weight of the water meter pit assembly to facilitate installation while still providing sufficient strength to support loads. Further, the modular nature of the frame assembly allows the height to be easily adjusted by an installer at the site.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A water meter pit assembly comprising:
a plastic frame including a base portion to be supported by a water pit column; and
a plastic cover releasably secured to the plastic frame for selective attachment and detachment from the plastic frame.

2. The water meter pit assembly according to claim 1, wherein the plastic frame comprises a modular assembly that includes at least the base portion and at least one spacer that are assembled together prior to being installed into a water pit.

3. The water meter pit assembly according to claim 2, wherein the base portion includes a first end to be supported by the water pit column and a second end that is attached to the at least one spacer, and wherein the base portion includes a flange extending about an outer periphery of the first end and a downwardly extending lip that cooperates with the flange to seat the base portion on the water pit column.

4. The water meter pit assembly according to claim 3, wherein the base portion includes a tapered outer surface that decreases in a direction extending from the flange toward the second end.

5. The water meter pit assembly according to claim 4, wherein the modular assembly includes a frost plate, and wherein the at least one spacer is fixed to the second end of the base portion and wherein the at least one spacer includes a flange portion extending inwardly from an inner peripheral surface of the at least one spacer, the flange portion supporting the frost plate.

6. The water meter pit assembly according to claim 5, wherein the at least one spacer comprises at least a first spacer and a second spacer, the first spacer being secured to the second end of the base portion and the second spacer being secured to the first spacer.

7. The water meter pit assembly according to claim 2 wherein the base portion comprises a tubular member having a first end to be supported by the water pit column and a second end that is secured to the at least one spacer at a first attachment interface.

8. The water meter pit assembly according to claim 7, wherein the first attachment interface comprises a snap-fit attachment.

9. The water meter pit assembly according to claim 8, wherein one of the base portion and the at least one spacer includes a resilient tab and the other of the base portion and the at least one spacer includes a flange that cooperates with the resilient tab to secure the at least one spacer to the base portion.

10. The water meter pit assembly according to claim 7 wherein the modular assembly includes a frost plate and wherein the at least one spacer comprises a tubular member having an outer peripheral surface and an inner peripheral surface, and wherein the at least one spacer includes a flange portion extending inwardly from the inner peripheral surface with the frost plate being supported on the flange portion.

11. The water meter pit assembly according to claim 10 wherein the frost plate comprises a cup-shaped component having an enclosed bottom and an outwardly extending peripheral flange that rests on the flange portion of the at least one spacer.

12. The water meter pit assembly according to claim 11 wherein the enclosed bottom provides a signal generator support surface for a signal generator that transmits water meter information from a water meter to a recipient, and wherein the frost plate includes at least one wire guide to receive a wire that extends from the signal generator to the water meter.

13. The water meter pit assembly according to claim 10, wherein the at least one spacer comprises at least a first spacer and a second spacer, the first spacer being secured to the second end of the base portion at the first attachment interface and the second spacer being secured to the first spacer at a second attachment interface.

14. The water meter pit assembly according to claim 13, wherein the second attachment interface comprises a snap-fit attachment.

15. The water meter pit assembly according to claim 14, wherein one of the first spacer and the second spacer includes a resilient tab and the other of the first spacer and the second spacer includes a flange that cooperates with the resilient tab to secure the second spacer to the first spacer.

16. The water meter pit assembly according to claim 15, wherein the plastic cover is secured to the second spacer.

17. The water meter pit assembly according to claim 13, wherein the second spacer comprises a tubular member that has a shorter height than the first spacer.

18. The water meter pit assembly according to claim 7, wherein the plastic cover is secured to the at least one spacer at a second attachment interface.

19. The water meter pit assembly according to claim 1, wherein the plastic frame supports a signal generator that transmits water meter information from a water meter to a recipient.

20. The water meter pit assembly according to claim 19, wherein the plastic frame includes at least one wire guide surface to support a wire connection extending from the signal generator, down through the water pit column, and to the water meter.

21. A method of assembling a water meter pit assembly comprising the steps of:
(a) providing a plastic frame including a base portion to be supported by a water pit column; and
(b) releasably securing a plastic cover to the plastic frame for selective attachment and detachment from the plastic frame.

22. The method according to claim 21 including forming the plastic frame by attaching at least one spacer to the base portion to form a modular frame assembly to be supported on the water pit column.

23. The method according to claim 22 securing a plastic cover to the at least one spacer to enclose the modular frame assembly.

24. The method according to claim 23 including selectively attaching and detaching the plastic cover from the at least one spacer to perform service operations as needed.

25. The method according to claim 22 including snap-fitting the at least one spacer to the base portion.

26. The method according to claim 22 wherein the spacer has an opening, and including the steps of inserting a frost plate through the opening and supporting the frost plate on the at least one spacer such that the base portion, the at least one spacer, and the frost plate form the modular frame assembly to be supported on a water pit column

27. The method according to claim 26 wherein the frost plate includes an outwardly extending flange portion and including the step of supporting the outwardly extending flange portion on an inwardly extending flange portion of the at least one spacer.

28. The method according to claim 22 wherein the at least one spacer comprises at least first and second spacers, and including securing the second spacer to the first spacer to increase a height of the modular frame assembly.

29. The method according to claim 28 including snap-fitting the first spacer to the base portion and snap-fitting the second spacer to the first spacer.

30. The method according to claim 29 including securing a plastic cover to the second spacer to enclose the modular frame assembly.
